(19) United States
(12) Patent Application Publication
(10) Pub. No.: US 2024/0355013 A1
(43) Pub. Date: Oct. 24, 2024

(54) IMAGE PROCESSING METHOD, APPARATUS, DEVICE AND STORAGE MEDIUM

(71) Applicant: Beijing Zitiao Network Technology Co., Ltd., Beijing (CN)

(72) Inventor: Shaohui LYU, Beijing (CN)

(21) Appl. No.: 18/682,400

(22) PCT Filed: Aug. 8, 2022
(86) PCT No.: PCT/CN2022/110798

§ 371 Date: Feb. 8, 2024

(30) Foreign Application Priority Data
Aug. 18, 2021 (CN) 202110948815.2

(51) Int. Cl. G06T 11/20

(52) U.S. Cl. CPC G06T 11/20; G06T 2200/24; G06T 2210/62

(57) ABSTRACT

The present disclosure provides an image processing method, apparatus, device and storage medium. The method includes: firstly, in a first image matting mode, when an image matting operation triggered for an image to be processed is received, an image matting result corresponding to the image matting operation is obtained as a first image matting result. Then, the first image matting result is drawn on a preset canvas; a second image matting result is drawn on the preset canvas, and the second image matting result is an image matting result for the image to be processed in a second image matting mode. Furthermore, based on the first image matting result and the second image matting result on the preset canvas, an image matting effect map of the image to be processed is determined.

### CROSS-REFERENCE TO RELATED APPLICATION

The present application claims priority of the Chinese Patent Application No. 202110948815.2, filed on Aug. 18, 2021 and titled “IMAGE PROCESSING METHOD, APPARATUS, DEVICE AND STORAGE MEDIUM”, the disclosure of which is incorporated herein by reference in its entirety.

### TECHNICAL FIELD

The present disclosure relates to the field of data processing, and in particular to an image processing method, an apparatus, a device and a storage medium.

### BACKGROUND

Image matting is one of the common operations in image processing. Specifically, it is to accurately separate a part of an original image from the original image into a separate image layer, which serves as an important basis for subsequent image processing.

At present, the image matting modes can be divided into a manual image matting mode, an automatic image matting mode and a semi-automatic image matting mode based on the degree of intelligence, and the image matting user can only select one of the image matting modes to perform an image matting processing on the original image, and cannot simultaneously use multiple image matting modes to perform an image matting processing on the same original image.

In practical application, different image matting modes have their own advantages. For example, the automatic image matting mode has a higher degree of intelligence and can save user's image matting time, while the semi-automatic image matting mode and the manual image matting mode have higher image matting precision and can improve image matting quality.

Therefore, how to realize the function of performing an image matting processing on the same original image by using multiple image matting modes simultaneously is an urgent technical problem to be solved at present.

### SUMMARY

In order to solve the above technical problem or at least partially solve the above technical problem, the present disclosure provides an image processing method, an apparatus, a device and a storage medium. By drawing image matting results in different image matting modes on the same canvas, the function of performing an image matting processing on the same image by simultaneously using multiple image matting modes is realized.

In a first aspect, the present disclosure provides an image processing method, which includes:

obtaining, in response to an image matting operation triggered for an image to be processed in a first image matting mode, an image matting result corresponding to the image matting operation as a first image matting result;

drawing the first image matting result on a preset canvas; wherein a second image matting result is drawn on the preset canvas, and the second image matting result is an image matting result for the image to be processed in a second image matting mode;

determining, based on the first image matting result and the second image matting result on the preset canvas, an image matting effect map of the image to be processed.

In an optional implementation, each of the first image matting mode and the second image matting mode is one selected from a preset automatic image matting mode, a preset manual image matting mode and a preset semi-automatic image matting mode, and the first image matting mode and the second image matting mode are different image matting modes.

In an optional implementation, the first image matting mode is a preset semi-automatic image matting mode, and obtaining, in response to the image matting operation triggered for the image to be processed in the first image matting mode, the image matting result corresponding to the image matting operation as the first image matting result, includes:

acquiring, in response to an image matting operation triggered for the image to be processed in the preset semi-automatic image matting mode, a stroke region corresponding to the image matting operation, and acquiring a previous image matting result corresponding to the image matting operation;

acquiring, based on the stroke region, the previous image matting result and the image to be processed, and according to a preset semi-automatic image matting algorithm, an image matting algorithm result map corresponding to the image matting operation;

obtaining, based on the image matting algorithm result map, an image matting result corresponding to the image matting operation as the first image matting result.

In an optional implementation, the previous image matting result corresponding to the image matting operation is stored in a preset array, and the preset array is used to store an image matting result corresponding to each image matting operation in the preset semi-automatic image matting mode according to an execution order;

before acquiring the previous image matting result corresponding to the image matting operation, the method further includes:

deleting an image matting result with an undo flag in the preset array; the undo

flag is marked for the image matting result when an image matting operation corresponding to the image matting result is undone.

In an optional implementation, obtaining, based on the image matting algorithm result map, the image matting result corresponding to the image matting operation as the first image matting result, includes:

performing a Gaussian blur processing on the image matting algorithm result map to obtain a Gaussian blur result map;

performing, after amplifying the Gaussian blur result map according to a preset multiple, a binarization processing to obtain the image matting result corresponding to the image matting operation as the first image matting result.

In an optional implementation, before drawing the first image matting result on the preset canvas, the method further includes:

determining a transparency value of a pixel point with larger transparency value among pixel points with same position coordinates in the first image matting result and a drawn image on the preset canvas as a transparency value of a pixel point with the same position coordinates on the preset canvas; the drawn image includes the second image matting result;

correspondingly, drawing the first image matting result on the preset canvas includes:

drawing, based on the transparency value of the pixel point on the preset canvas, the first image matting result on the preset canvas.

In a second aspect, the present disclosure provides an image processing apparatus, including:

an obtaining module, configured to obtain, in response to an image matting operation triggered for an image to be processed in a first image matting mode, an image matting result corresponding to the image matting operation as a first image matting result;

a drawing module, configured to draw the first image matting result on a preset canvas; a second image matting result is drawn on the preset canvas, and the second image matting result is an image matting result for the image to be processed in a second image matting mode;

a first determining module, configured to determine, based on the first image matting result and the second image matting result on the preset canvas, an image matting effect map of the image to be processed.

In a third aspect, the present disclosure provides a computer-readable storage medium, instructions are stored on the computer-readable storage medium, and the instructions, upon being executed by a terminal device, cause the terminal device to implement the above-described method.

In a fourth aspect, the present disclosure provides a device, including: a memory, a processor, and computer program that is stored on the memory and executable on the processor, the processor, upon executing the computer program, implements the above-described method.

In a fifth aspect, the present disclosure provides a computer program product, the computer program product includes computer program/instructions, the computer program/instructions, when executed by a processor, implement the above-described method.

Compared with the prior art, the technical solutions provided by the embodiments of the present disclosure have at least the following advantages.

Embodiments of the present disclosure provide an image processing method. Firstly, in a first image matting mode, when an image matting operation triggered for an image to be processed is received, an image matting result corresponding to the image matting operation is obtained as a first image matting result. Then, the first image matting result is drawn on a preset canvas; a second image matting result is drawn on the preset canvas, and the second image matting result is an image matting result for the image to be processed in a second image matting mode. Furthermore, based on the first image matting result and the second image matting result on the preset canvas, an image matting effect map of the image to be processed is determined. In the embodiments of the present disclosure, by drawing image matting results of the same image to be processed in different image matting modes on the same canvas, the function of performing an image matting processing on the same image by simultaneously using multiple image matting modes is realized.

### BRIEF DESCRIPTION OF DRAWINGS

The accompanying drawings, which are hereby incorporated in and constitute a part of the present description, illustrate embodiments of the present disclosure, and together with the description, serve to explain the principles of the embodiments of the present disclosure.

To describe the technical solutions in the embodiments of the present disclosure or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 is a flowchart of an image processing method provided by embodiments of the present disclosure;

FIG. 2 is a schematic diagram of drawing an image matting result on a preset canvas provided by embodiments of the present disclosure;

FIG. 3 is a schematic diagram of an image matting result in a semi-automatic image matting mode in the prior art;

FIG. 4 is a schematic diagram of an image matting result in a semi-automatic image matting mode provided by embodiments of the present disclosure;

FIG. 5 is a schematic structural diagram of an image processing apparatus provided by embodiments of the present disclosure; and

FIG. 6 is a schematic structural diagram of an image processing device provided by embodiments of the present disclosure.

### DETAILED DESCRIPTION

To provide a clearer understanding of the objectives, features, and advantages of the embodiments of the present disclosure, the solutions in the embodiments of the present disclosure will be further described below. It should be noted that the embodiments in the present disclosure and features in the embodiments may be combined with one another without conflict.

Many specific details are described below to help fully understand the embodiments of the present disclosure. However, the embodiments of the present disclosure may also be implemented in other manners different from those described herein. Apparently, the described embodiments in the specification are merely some rather than all of the embodiments of the present disclosure.

At present, the image matting modes can be divided into a manual image matting mode, an automatic image matting mode and a semi-automatic image matting mode based on degree of intelligence. The manual image matting mode means that an image matting result is generated only based on stroke region drawn manually by a user, in which the degree of intelligence is low, but the image matting precision is high, and the user can manually select the image matting region of interest. The automatic image matting mode means that the image matting result is automatically generated based on an image matting model or image matting algorithm, etc., in which the degree of intelligence is high, but the image matting result may not meet user's needs. The semi-automatic image matting mode means that after the user draws the stroke region manually, the image matting result containing the stroke region drawn manually by the user is generated based on characteristic correlation between pixel points in the stroke region and pixel points in a surrounding region.

In practical application, since different image matting modes have their own advantages, in order to improve image matting efficiency and also ensure image matting quality, multiple image matting modes can be used to perform an image matting processing on the same image simultaneously, so as to obtain an image matting result that meets user's needs.

Therefore, embodiments of the present disclosure provide an image processing method. Firstly, in a first image matting mode, when an image matting operation triggered for an image to be processed is received, an image matting result corresponding to the image matting operation is obtained as a first image matting result. Then, the first image matting result is drawn on a preset canvas; a second image matting result is drawn on the preset canvas, and the second image matting result is an image matting result for the image to be processed in a second image matting mode. Furthermore, based on the first image matting result and the second image matting result on the preset canvas, an image matting effect map of the image to be processed is determined. In the embodiments of the present disclosure, by drawing image matting results of the same image to be processed in different image matting modes on the same canvas, the function of performing an image matting processing on the same image by simultaneously using multiple image matting modes is realized.

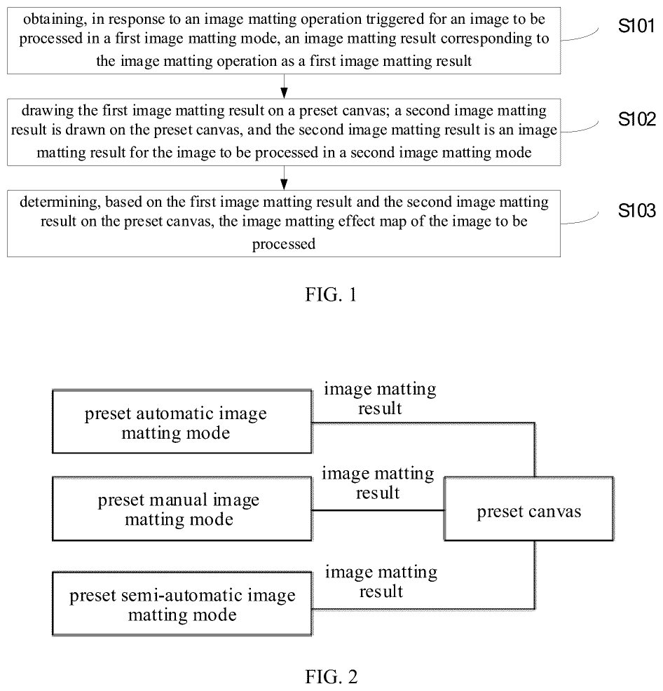

Based on this, embodiments of the present disclosure provide an image processing method. Referring to FIG. 1, which is a flowchart of an image processing method provided by embodiments of the present disclosure, the method includes:

S101: obtaining, in response to an image matting operation triggered for an image to be processed in a first image matting mode, an image matting result corresponding to the image matting operation as a first image matting result.

In the embodiment of the present disclosure, the first image matting mode can be any selected from a preset automatic image matting mode, a preset manual image matting mode and a preset semi-automatic image matting mode.

In practical application, in the first image matting mode, if the image matting operation triggered for the image to be processed is received, the image matting result corresponding to the image matting operation is obtained as the first image matting result.

In an alternative implementation, if the first image matting mode is the preset automatic image matting mode, the image matting operation triggered for the image to be processed may include operations, such as clicking or touching a preset automatic image matting button, etc. Accordingly, after receiving the operation of clicking or touching the preset automatic image matting button for the image to be processed, an automatic image matting processing is performed on the image to be processed to obtain the first image matting result. The embodiments of the present disclosure do not limit the way by which the automatic image matting processing is performed on the image to be processed.

In another alternative implementation, if the first image matting mode is the preset manual image matting mode, the image matting operation triggered for the image to be processed may be an operation of drawing a stroke on the image to be processed by a user. Accordingly, after receiving the operation of drawing the stroke on the image to be processed, an image matting processing is performed based on the stroke region of the stroke to obtain the first image matting result. The region corresponding to the first image matting result coincides with the stroke region of the stroke.

In another alternative implementation, if the first image matting mode is the preset semi-automatic image matting mode, the image matting operation triggered for the image to be processed may also be an operation of drawing a stroke on the image to be processed by a user. Accordingly, after receiving the operation of drawing the stroke on the image to be processed, based on the characteristic correlation between pixel points in the stroke region of the stroke and pixel points in surrounding region, an image matting result containing the stroke region is obtained as the first image matting result. The semi-automatic image matting algorithm adopted by the preset semi-automatic image matting mode in the embodiment of the present disclosure is not limited here.

S102: drawing the first image matting result on a preset canvas; a second image matting result is drawn on the preset canvas, and the second image matting result is an image matting result for the image to be processed in a second image matting mode.

In the embodiment of the present disclosure, after obtaining the first image matting result corresponding to the image matting operation, the first image matting result is drawn on the preset canvas.

In practical application, image matting results of the same image to be processed in different image matting modes are all drawn on the same canvas, that is, drawn on the preset canvas in the embodiments of the present disclosure, thus ensuring that the function of performing an image matting processing on the same image to be processed by using different image matting modes can be realized, and satisfying the diverse image matting needs of users.

In practical application, assuming that the preset canvas contains an image that is drawn based on the image matting result for the image to be processed in the second image matting mode, the first image matting result in the first image matting mode is drawn on the preset canvas after obtaining the first image matting result for the image to be processed in the first image matting mode.

In practical application, if the first image matting result in the first image matting mode has an overlapping region with a drawn image on the preset canvas, in order to ensure the drawing effect, transparency values of pixel points drawn in the overlapping region on the preset canvas can be set. Specifically, the transparency value of a pixel point with larger transparency value among pixel points with the same position coordinates in the drawn image on the preset canvas and the first image matting result in the first image matting mode can be determined as a transparency value of the pixel point with the same position coordinates on the preset canvas, so as to avoid transparency of the overlapping region being lower than that of other regions, which affects the display effect of the image matting result.

For example, assuming that a first pixel point in the first image matting result in the first image matting mode has the same position coordinates as a second pixel point in the drawn image on the preset canvas, the larger transparency value among the transparency values of the first pixel point and the second pixel point is determined as the transparency value of the pixel point with the same position coordinates on the preset canvas. Then, the first image matting result is drawn on the preset canvas based on the transparency value of the pixel point on the preset canvas.

As shown in FIG. 2, which is a schematic diagram drawing an image matting result on a preset canvas provided by embodiments of the present disclosure, the image matting results in the preset automatic image matting mode, the preset manual image matting mode and the preset semi-automatic image matting mode can all be output to the same preset canvas, thus ensuring that an image matting effect map of the image to be processed that is displayed based on the preset canvas is the image matting effect map that uses multiple matting modes simultaneously, and improving the use experience of image matting for users.

S103: determining, based on the first image matting result and the second image matting result on the preset canvas, the image matting effect map of the image to be processed.

In the embodiments of the present disclosure, after the image matting results for the same image to be processed in different image matting modes are drawn on the preset canvas, the image matting effect map of the image to be processed is displayed based on the image drawn on the preset canvas. Since the image drawn on the preset canvas contains the image matting results of the same image to be processed in various image matting modes, the embodiments of the present disclosure can realize the function of performing an image matting processing on the same image by using multiple image matting modes simultaneously.

In the image processing method provided by the embodiment of the present disclosure, firstly, in a first image matting mode, when an image matting operation triggered for an image to be processed is received, an image matting result corresponding to the image matting operation is obtained as a first image matting result. Then, the first image matting result is drawn on a preset canvas; a second image matting result is drawn on the preset canvas, and the second image matting result is an image matting result for the image to be processed in a second image matting mode. Furthermore, based on the first image matting result and the second image matting result on the preset canvas, an image matting effect map of the image to be processed is determined. In the embodiments of the present disclosure, by drawing image matting results of the same image to be processed in different image matting modes on the same canvas, the function of performing an image matting processing on the same image by simultaneously using multiple image matting modes is realized.

Based on the above method embodiment, embodiments of the present disclosure provide a method of acquiring an image matting result in a preset semi-automatic image matting mode. Specifically, in the preset semi-automatic image matting mode, the determining of the image matting result corresponding to current image matting operation is not only related to the stroke region currently drawn by the user, but also related to a previous image matting result corresponding to the current image matting operation.

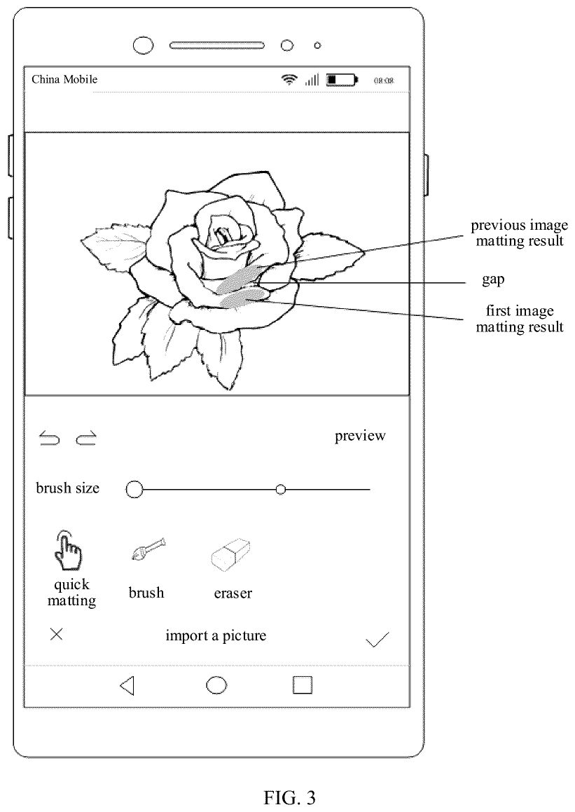

As shown in FIG. 3, which is a schematic diagram of an image matting result in a semi-automatic image matting mode in the prior art, the semi-automatic image matting mode corresponds to the “quick image matting” button in FIG. 3. There is a gap between the previous image matting result corresponding to the current image matting operation and the first image matting result corresponding to the current image matting operation, as shown in FIG. 3. Usually, the gap in FIG. 3 is not drawn due to the limitation of user's operation fineness, but in fact, the gap in FIG. 3 is an image matting region of interest of the image matting user. Therefore, in the semi-automatic image matting mode, the gap may be automatically identified as being contained in the image matting result corresponding to the current image matting operation.

In order to realize the above function, the embodiment of the present disclosure at least needs to store a previous image matting result corresponding to the current image matting operation in the preset semi-automatic image matting mode. Upon receiving an image matting operation triggered for the image to be processed in the preset semi-automatic image matting mode, a stroke region corresponding to the image matting operation is acquired, and a previous image matting result corresponding to the image matting operation is acquired. Then, the stroke region, the previous image matting result and the image to be processed are used as input parameters of a preset semi-automatic image matting algorithm, and after processing according to the preset semi-automatic image matting algorithm, an image matting algorithm result map corresponding to the image matting operation is obtained.

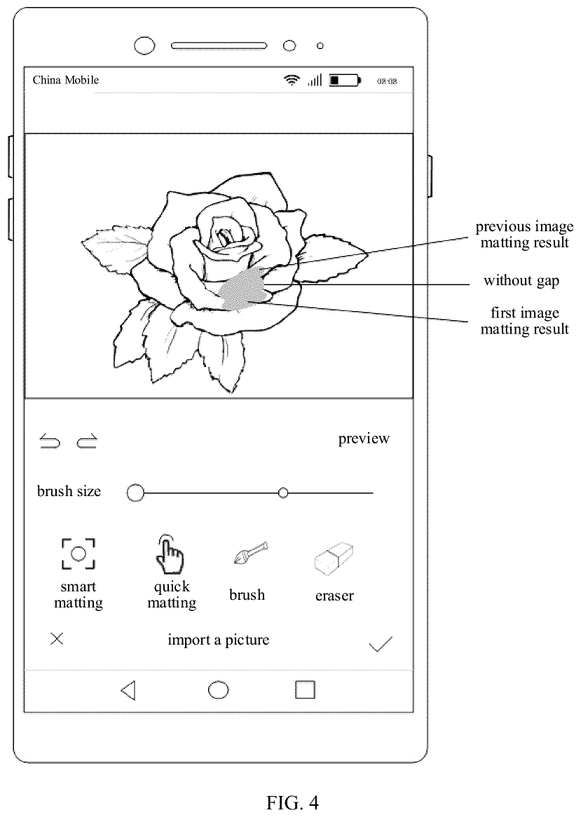

It is worth noting that the embodiments of the present disclosure do not limit the implementation of the preset semi-automatic image matting algorithm. The preset semi-automatic image matting algorithm is used to determine the image matting algorithm result map corresponding to the image matting operation based on the stroke region and the previous image matting result corresponding to the current image matting operation, and the image to be processed. The preset semi-automatic image matting algorithm may identify the gap shown in FIG. 3 as being contained in the image matting result corresponding to the image matting operation. As shown in FIG. 4, the previous image matting result may be an image matting result generated by a user by clicking the “smart image matting” button to enter the automatic image matting mode, or may be an image matting result generated by the user by clicking the “quick image matting” button to enter the semi-automatic image matting mode. After the user clicks the “quick image matting” button again to enter the preset semi-automatic image matting mode, the stroke region currently drawn by the user is acquired, and the image matting algorithm result map is determined based on the previous image matting result, the stroke region and the image to be processed by using the preset semi-automatic image matting algorithm. As shown in FIG. 4, which is a schematic diagram of the image matting result in the semi-automatic image matting mode obtained after the processing of the embodiment of the present disclosure, it can be seen that the gap shown in FIG. 3 can be automatically identified as being contained in the image matting result corresponding to the current image matting operation in the semi-automatic image matting mode.

In an alternative implementation, in the semi-automatic image matting mode, a preset array is used to store the image matting result corresponding to the image matting operation in each step according to an execution order of the image matting operations, so as to determine the image matting result of the current image matting operation in the semi-automatic image matting mode.

In practical application, the semi-automatic image matting mode has the function of undo operation. As shown in FIG. 4, the undo operation corresponds to a flag of “Undo Forward”. The embodiments of the present disclosure can realize the undo operation based on the image matting result corresponding to each image matting operation that stored in the preset array according to the execution order. Specifically, when an undo operation for any image matting operation is received, the image matting result corresponding to this image matting operation in the preset array may be marked with an undo flag, so as to indicate that the undo operation is performed on the image matting result.

In practical application, in the semi-automatic image matting mode, when a new stroke operation is received, the image matting result with the undo flag in the preset array is deleted, and an image matting result corresponding to the new stroke operation is stored in the preset array, so as to ensure to undo to a valid image matting result instead of the image matting result with the undo flag when the undo operation is performed again.

In addition, in practical application, in the semi-automatic image matting mode, the image matting algorithm result map output by the preset semi-automatic image matting algorithm is a small map, usually with a size smaller than 512*512, so as to save computing resources of the system. However, the image matting result drawn on the preset canvas is a large map, usually with a size of 2048*1080. Therefore, before drawing the image matting algorithm result map on the preset canvas, the small map is firstly amplified to obtain a corresponding large map. Therefore, in the semi-automatic image matting mode, the embodiment of the present disclosure can save computing resources of the system while ensuring user's experience.

Specifically, in order to reduce the jaggedness of the image matting algorithm result map (i.e., the small map), the embodiments of the present disclosure firstly perform a Gaussian blur processing on the image matting algorithm result map corresponding to the image matting operation to obtain a Gaussian blur result map. Then, after amplifying the Gaussian blur result map according to a preset multiple, a binarization processing is performed to obtain the image matting result corresponding to the image matting operation. After the binarization processing, the edges and corners of the image matting result are made clear, thus improving the quality of the image matting effect map of the image to be processed.

In an alternative implementation, an operator (m, n) may be used to perform the Gaussian blur processing on the image matting algorithm result map for 1 to 3 times, where m or n may be any value in the range of 3 to 5.

In another alternative implementation, any value in the range of 0.6 to 0.8 may be used as a threshold of the binarization processing, so as to obtain the image matting effect map with clear edges and corners.

In the image processing method provided by the embodiments of the present disclosure, the image matting algorithm result map output by the preset semi-automatic image matting algorithm in the semi-automatic image matting mode is a small map, and the small graph is amplified just before being drawn on the preset canvas, thereby saving computing resources of the system while ensuring user's experience.

In addition, the embodiment of the present disclosure can further reduce the jaggedness of the image matting algorithm result map by performing the Gaussian blur processing on the image matting algorithm result map, thereby improving the quality of the image matting effect map of the image to be processed.

In addition, the embodiments of the present disclosure can further obtain the image matting effect map with clear edges and corners by the binarization processing, thereby further improving the quality of the image matting effect map of the image to be processed.

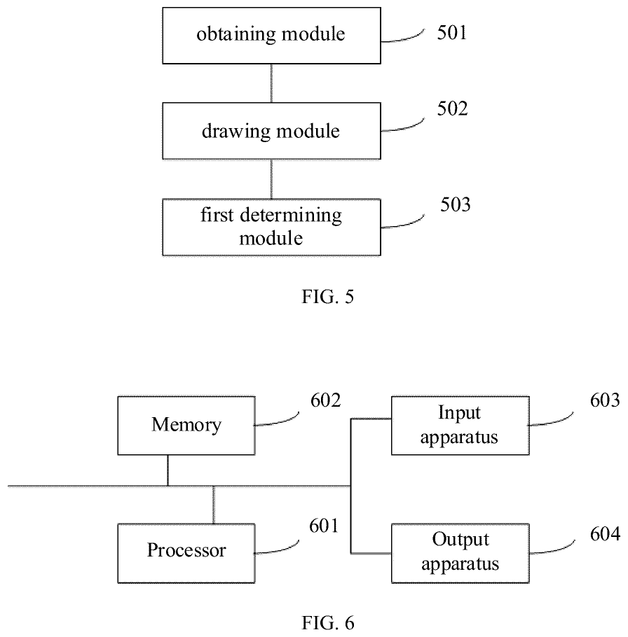

Based on the above method embodiments, the present disclosure further provides an image processing apparatus. Referring to FIG. 5, which is a schematic structural diagram of an image processing apparatus provided by embodiments of the present disclosure, the apparatus includes:

an obtaining module 501, configured to obtain, in response to an image matting operation triggered for an image to be processed in a first image matting mode, an image matting result corresponding to the image matting operation as a first image matting result;

a drawing module 502, configured to draw the first image matting result on a preset canvas; a second image matting result is drawn on the preset canvas, and the second image matting result is an image matting result for the image to be processed in a second image matting mode;

a first determining module 503, configured to determine, based on the first image matting result and the second image matting result on the preset canvas, an image matting effect map of the image to be processed.

In an alternative implementation, each of the first image matting mode and the second image matting mode is one selected from a preset automatic image matting mode, a preset manual image matting mode and a preset semi-automatic image matting mode, and the first image matting mode and the second image matting mode are different image matting modes.

In an alternative implementation, the first image matting mode is a preset semi-automatic image matting mode, and the obtaining module includes:

a first acquiring sub-module, configured to acquire, in response to an image matting operation triggered for the image to be processed in the preset semi-automatic image matting mode, a stroke region corresponding to the image matting operation, and acquire a previous image matting result corresponding to the image matting operation;

a processing sub-module, configured to input the stroke region, the previous image matting result and the image to be processed into a preset semi-automatic image matting algorithm, and output an image matting algorithm result map corresponding to the image matting operation after being processed by the preset semi-automatic image matting algorithm;

an obtaining sub-module, configured to obtain, based on the image matting algorithm result map corresponding to the image matting operation, the image matting result corresponding to the image matting operation.

In an alternative implementation, the previous image matting result corresponding to the image matting operation is stored in a preset array, and the preset array is used to store an image matting result corresponding to each image matting operation in the preset semi-automatic image matting mode according to an execution order; and the apparatus further includes:

a deleting module, configured to delete an image matting result with an undo flag in the preset array; the undo flag is marked for the image matting result when an image matting operation corresponding to the image matting result is undone.

In an alternative implementation, the obtaining sub-module includes:

a Gaussian sub-module, configured to perform a Gaussian blur processing on the image matting algorithm result map corresponding to the image matting operation to obtain a Gaussian blur result map;

a binarization sub-module, configured to perform, after amplifying the Gaussian blur result map according to a preset multiple, a binarization processing to obtain the image matting result corresponding to the image matting operation.

In an alternative implementation, the apparatus further includes:

a second determining module, configured to determine a transparency value of a pixel point with larger transparency value among pixel points with same position coordinates in the first image matting result and a drawn image on the preset canvas as a transparency value of a pixel point with the same position coordinates on the preset canvas; the drawn image includes the second image matting result;

correspondingly, the drawing module is specifically configured to:

draw, based on the transparency value of the pixel point on the preset canvas, the first image matting result on the preset canvas.

In the image processing apparatus provided by the embodiments of the present disclosure, firstly, in a first image matting mode, when an image matting operation triggered for an image to be processed is received, an image matting result corresponding to the image matting operation is obtained as a first image matting result. Then, the first image matting result is drawn on a preset canvas; a second image matting result is drawn on the preset canvas, and the second image matting result is an image matting result for the image to be processed in a second image matting mode. Furthermore, based on the first image matting result and the second image matting result on the preset canvas, an image matting effect map of the image to be processed is determined. In the embodiments of the present disclosure, by drawing image matting results of the same image to be processed in different image matting modes on the same canvas, the function of performing an image matting processing on the same image by simultaneously using multiple image matting modes is realized.

In addition to the above method and apparatus, embodiments of the present disclosure further provide a computer-readable storage medium, instructions are stored on the computer-readable storage medium, and the instructions, upon being executed by a terminal device, cause the terminal device to implement the image processing method described in the embodiments of the present disclosure.

Embodiments of the present disclosure further provides a computer program product, including computer program/instructions, characterized in that the computer program/instructions, when executed by a processor, implement the image processing method described in the embodiments of the present disclosure.

In addition, embodiments of the present disclosure further provide an image processing device, as shown in FIG. 6, which may include:

a processor 601, a memory 602, an input apparatus 603 and an output apparatus 604. The number of the processor 601 in the image processing device may be one or more, and one processor is taken as an example in FIG. 6. In some embodiments of the present disclosure, the processor 601, the memory 602, the input apparatus 603 and the output apparatus 604 may be connected through a bus or other means, and the connection through the bus is taken as an example in FIG. 6.

The memory 602 may be configured to store software programs and modules, and the processor 601 executes various functional applications and data processing of the image processing device by running the software programs and modules stored in the memory 602. The memory 602 may mainly include a program storage region and a data storage region, and the program storage region may store an operating system, application programs required by at least one function, etc. In addition, the memory 602 may include high-speed random-access memory, and may also include non-volatile memory, such as at least one magnetic disk memory, flash memory, or other volatile solid-state memory. The input apparatus 603 may be configured to receive inputted digital or character information and generate signal input related to user settings and function control of the image processing device.

Specifically, in the present embodiment, the processor 601 may follow the following instructions to load executable files corresponding to the processes of one or more application programs into the memory 602, and the processor 601 may run the application programs stored in the memory 602 to realize various functions of the above-mentioned image processing device.

It should be noted that in the present disclosure, relational terms, such as “first” and “second”, etc., are merely used to distinguish one entity or operation from another entity or operation, and do not necessarily require or imply that there is any such factual relationship or order between these entities or operations. Moreover, the terms “including”, “comprising” or any other variation thereof are intended to cover non-exclusive inclusion, so that a process, method, article or device that includes a series of elements includes not only these elements, but also other elements that are not explicitly listed or elements that are inherent to such process, method, article or device. Without further restrictions, an element defined by the phrase “including a/an . . . ” does not exclude the existence of other identical elements in the process, method, article or device that includes the element.

What is described above is only the specific embodiments of the present disclosure, so that those skilled in the art can understand or realize the present disclosure. Many modifications to these embodiments will be obvious to those skilled in the art, and the general principles defined herein may be implemented in other embodiments without departing from the spirit or scope of the present disclosure. Therefore, the present disclosure is not limited to the embodiments described herein, but to be accorded the widest scope that is consistent with the principles and novel features disclosed herein.

1. An image processing method, wherein the method comprises:
obtaining, in response to an image matting operation triggered for an image to be processed in a first image matting mode, an image matting result corresponding to the image matting operation as a first image matting result;
drawing the first image matting result on a preset canvas; wherein a second image matting result is drawn on the preset canvas, and the second image matting result is an image matting result for the image to be processed in a second image matting mode;
determining, based on the first image matting result and the second image matting result on the preset canvas, an image matting effect map of the image to be processed.

2. The method according to claim 1, wherein each of the first image matting mode and the second image matting mode is one selected from a preset automatic image matting mode, a preset manual image matting mode and a preset semi-automatic image matting mode, and the first image matting mode and the second image matting mode are different image matting modes.

3. The method according to claim 1, wherein the first image matting mode is a preset semi-automatic image matting mode, and obtaining, in response to the image matting operation triggered for the image to be processed in the first image matting mode, the image matting result corresponding to the image matting operation as the first image matting result, comprises:
acquiring, in response to an image matting operation triggered for the image to be processed in the preset semi-automatic image matting mode, a stroke region corresponding to the image matting operation, and acquiring a previous image matting result corresponding to the image matting operation;
acquiring, based on the stroke region, the previous image matting result and the image to be processed, and according to a preset semi-automatic image matting algorithm, an image matting algorithm result map corresponding to the image matting operation;
obtaining, based on the image matting algorithm result map, an image matting result corresponding to the image matting operation as the first image matting result.

4. The method according to claim 3, wherein the previous image matting result corresponding to the image matting operation is stored in a preset array, and the preset array is used to store an image matting result corresponding to each image matting operation in the preset semi-automatic image matting mode according to an execution order;
before acquiring the previous image matting result corresponding to the image matting operation, the method further comprises:
deleting an image matting result with an undo flag in the preset array; wherein the undo flag is marked for the image matting result when an image matting operation corresponding to the image matting result is undone.

5. The method according to claim 3, wherein obtaining, based on the image matting algorithm result map, the image matting result corresponding to the image matting operation as the first image matting result, comprises:
performing a Gaussian blur processing on the image matting algorithm result map to obtain a Gaussian blur result map;
performing, after amplifying the Gaussian blur result map according to a preset multiple, a binarization processing to obtain the image matting result corresponding to the image matting operation as the first image matting result.

6. The method according to claim 1, wherein before drawing the first image matting result on the preset canvas, the method further comprises:
determining a transparency value of a pixel point with larger transparency value among pixel points with same position coordinates in the first image matting result and a drawn image on the preset canvas as a transparency value of a pixel point with the same position coordinates on the preset canvas; wherein the drawn image comprises the second image matting result;
correspondingly, drawing the first image matting result on the preset canvas comprises:
drawing, based on the transparency value of the pixel point on the preset canvas, the first image matting result on the preset canvas.

7. An image processing apparatus, wherein the apparatus comprises:
an obtaining module, configured to obtain, in response to an image matting operation triggered for an image to be processed in a first image matting mode, an image matting result corresponding to the image matting operation as a first image matting result;
a drawing module, configured to draw the first image matting result on a preset canvas; wherein a second image matting result is drawn on the preset canvas, and the second image matting result is an image matting result for the image to be processed in a second image matting mode;
a first determining module, configured to determine, based on the first image matting result and the second image matting result on the preset canvas, an image matting effect map of the image to be processed.

8. A computer-readable storage medium, wherein instructions are stored on the computer-readable storage medium, and the instructions, upon being executed by a terminal device, cause the terminal device to implement:
obtaining, in response to an image matting operation triggered for an image to be processed in a first image matting mode, an image matting result corresponding to the image matting operation as a first image matting result;
drawing the first image matting result on a preset canvas; wherein a second image matting result is drawn on the preset canvas, and the second image matting result is an image matting result for the image to be processed in a second image matting mode;
determining, based on the first image matting result and the second image matting result on the preset canvas, an image matting effect map of the image to be processed.

9. A device, comprising: a memory, a processor, and computer program stored on the memory and executable on the processor, wherein the processor, upon executing the computer program, implements the method according to claim 1.

10. A computer program product, wherein the computer program product comprises computer program or instructions, and the computer program or instructions, when executed by a processor, implement the method according to claim 1.

11. The apparatus according to claim 7, wherein each of the first image matting mode and the second image matting mode is one selected from a preset automatic image matting mode, a preset manual image matting mode and a preset semi-automatic image matting mode, and the first image matting mode and the second image matting mode are different image matting modes.

12. The apparatus according to claim 7, wherein the first image matting mode is a preset semi-automatic image matting mode, and the obtaining module comprises:
a first acquiring sub-module, configured to acquire, in response to an image matting operation triggered for the image to be processed in the preset semi-automatic image matting mode, a stroke region corresponding to the image matting operation, and acquiring a previous image matting result corresponding to the image matting operation;
a processing sub-module, configured to acquire, based on the stroke region, the previous image matting result and the image to be processed, and according to a preset semi-automatic image matting algorithm, an image matting algorithm result map corresponding to the image matting operation;
an obtaining sub-module, configured to obtain, based on the image matting algorithm result map, an image matting result corresponding to the image matting operation as the first image matting result.

13. The apparatus according to claim 12, wherein the previous image matting result corresponding to the image matting operation is stored in a preset array, and the preset array is used to store an image matting result corresponding to each image matting operation in the preset semi-automatic image matting mode according to an execution order;
before acquiring the previous image matting result corresponding to the image matting operation, the apparatus further comprises:
a deleting module, configured to delete an image matting result with an undo flag in the preset array; wherein the undo flag is marked for the image matting result when an image matting operation corresponding to the image matting result is undone.

14. The apparatus according to claim 12, wherein the obtaining sub-module comprises:
a Gaussian sub-module, configured to perform a Gaussian blur processing on the image matting algorithm result map to obtain a Gaussian blur result map;
a binarization sub-module, configured to perform, after amplifying the Gaussian blur result map according to a preset multiple, a binarization processing to obtain the image matting result corresponding to the image matting operation as the first image matting result.

15. The apparatus according to claim 7, wherein before drawing the first image matting result on the preset canvas, the apparatus further comprises:
a second determining module, configured to determine a transparency value of a pixel point with larger transparency value among pixel points with same position coordinates in the first image matting result and a drawn image on the preset canvas as a transparency value of a pixel point with the same position coordinates on the preset canvas; wherein the drawn image comprises the second image matting result;
correspondingly, the drawing module is configured to:
draw, based on the transparency value of the pixel point on the preset canvas, the first image matting result on the preset canvas.

16. The computer-readable storage medium according to claim 8, wherein each of the first image matting mode and the second image matting mode is one selected from a preset automatic image matting mode, a preset manual image matting mode and a preset semi-automatic image matting mode, and the first image matting mode and the second image matting mode are different image matting modes.

17. The computer-readable storage medium according to claim 8, wherein the first image matting mode is a preset semi-automatic image matting mode, and the instructions further cause the terminal device to implement:
acquiring, in response to an image matting operation triggered for the image to be processed in the preset semi-automatic image matting mode, a stroke region corresponding to the image matting operation, and acquiring a previous image matting result corresponding to the image matting operation;
acquiring, based on the stroke region, the previous image matting result and the image to be processed, and according to a preset semi-automatic image matting algorithm, an image matting algorithm result map corresponding to the image matting operation;
obtaining, based on the image matting algorithm result map, an image matting result corresponding to the image matting operation as the first image matting result.

18. The computer-readable storage medium according to claim 17, wherein the previous image matting result corresponding to the image matting operation is stored in a preset array, and the preset array is used to store an image matting result corresponding to each image matting operation in the preset semi-automatic image matting mode according to an execution order;
before acquiring the previous image matting result corresponding to the image matting operation, the instructions further cause the terminal device to implement:
deleting an image matting result with an undo flag in the preset array; wherein the undo flag is marked for the image matting result when an image matting operation corresponding to the image matting result is undone.

19. The computer-readable storage medium according to claim 17, wherein the instructions further cause the terminal device to implement:
performing a Gaussian blur processing on the image matting algorithm result map to obtain a Gaussian blur result map;
performing, after amplifying the Gaussian blur result map according to a preset multiple, a binarization processing to obtain the image matting result corresponding to the image matting operation as the first image matting result.

20. The computer-readable storage medium according to claim 8, wherein before drawing the first image matting result on the preset canvas, the instructions further cause the terminal device to implement:
determining a transparency value of a pixel point with larger transparency value among pixel points with same position coordinates in the first image matting result and a drawn image on the preset canvas as a transparency value of a pixel point with the same position coordinates on the preset canvas; wherein the drawn image comprises the second image matting result;
correspondingly, drawing the first image matting result on the preset canvas comprises:
drawing, based on the transparency value of the pixel point on the preset canvas, the first image matting result on the preset canvas.
